(19) United States
(12) Patent Application Publication
(10) Pub. No.: US 2008/0004996 A1
(43) Pub. Date: Jan. 3, 2008

(54) Player tracking system with player preference database

(76) Inventor: Brian L. Kuehling, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 11/471,175

(22) Filed: Jun. 19, 2006

(51) Int. Cl. G06Q 10/00

(52) U.S. Cl. 705/28

(57) ABSTRACT

A system and method for providing service to a casino customer is disclosed. A database is provided for collecting and storing customer preference information. The customer is preferably provided with a casino card or other element that identifies the customer and is used to pair the customer with his or her preference information. A first communication link is provided between the database and a service center, such as a bar, to send customer preference information, such as a beverage, for preparation. A second communication link is provided between a tracking server and the service center to transmit information regarding the specific location of the customer. After the service center prepares the preferred item, it is delivered to the customer. In one embodiment, the service system is associated with a casino customer reward system that rewards a customer based on gaming activity.

### FIELD OF THE INVENTION

The present invention relates to personalized customer service and, in particular to a system and method for providing service to a casino customer based on the personal preferences of the customer in conjunction with data regarding customer location within the casino.

### BACKGROUND OF THE INVENTION

Patrons visit casinos for both the excitement that gambling provides as well as the anticipation of possibly winning money. In addition, entertainment is provided by playing slot machines or table games. In order for the gaming industry to thrive, casino operators work diligently to provide superior service to their patrons. As a service business, the gaming patrons are customers who seek not only to enjoy the gaming experience, but also to be served in a manner that makes them want to return to the property.

Many people can entertain themselves at a gaming machine for hours at a time. During these extended periods, a player likely will desire refreshments, such as a beverage and/or snack, to satisfy a feeling of thirst and/or hunger. Furthermore, some players who smoke will typically have a desire to smoke their favorite tobacco product.

Casino operators typically provide beverage service while the patron is at a gaming machine or table. More specifically, the service staff (waiter or waitress, hereinafter waitress) is employed to walk the casino floor and receive beverage orders from the patrons. The waitresses then take the orders to a bar or lounge for preparation and return to the player with their beverage of choice. The refreshments may be provided free of charge, or payment may be required.

While this approach to providing service to a customer is adequate, it is recognized that more personalized and customized service may be provided. For example, the server may not know the customer's name or may not remember the customer's usual refreshment preference. Hence, even though a patron may often frequent the casino, they may still not feel like regular and appreciated customers. As casino size increases, this problem becomes more prevalent.

Another drawback with prior art systems is that such prior art systems are very inefficient. The majority of the waitress's time is spent walking the floor to locate unknown customers and obtain their drink orders. This reduces the number of drinks served and hence requires more waitresses per casino to serve the desired number of drinks per hour.

There is, therefore, a need to enhance service to a casino customer in an efficient manner that is also more personalized and thus engenders a desire by the customer to return to the casino based on the personalized service.

### SUMMARY OF THE INVENTION

The advantages and other novel features of the invention will be set forth in part in the description that follows and in part will become apparent to those skilled in the art upon examination of the following or may be learned with the practice of the invention.

To achieve the foregoing, and in accordance with the disclosure that follows, a system for providing service to a casino customer is provided. In one embodiment, the system comprises a database for collecting and storing customer preference information. The system further includes a service center for preparing preferred goods and services for the customer. While this typically contemplates preferred beverages, it is within the scope of the invention that the customer may be provided with a preferred smoking product or snack item.

In an important aspect of the invention, the casino customer service system includes a server, responsive to an input device, for tracking the location of the customer. By continuously noting the location of a customer within a casino, superior personalized service is facilitated.

One embodiment of the casino customer service system comprises a first communication link between the database and the service center to send customer preference information to the service center. In the context of providing a beverage, this first communication link allows the beverage preparer, such as a bar or lounge, to identify the specific beverage preference of the customer.

One embodiment of the invention comprises a second communication link between the tracking server and the service center to send customer location information to the service center. The invention further contemplates means for delivering the preferred goods and services to the customer. While this is accomplished presently by the waitress, it is within the scope of the invention to have automated delivery elements as technology progresses. The ability to immediately pinpoint the location of the customer allows for the convenient and efficient delivery of goods and services to that customer.

In one embodiment of the invention, the casino customer service system is associated with a casino customer rewards system that rewards the customer based on gaming activity. Existing casino customer reward systems presently have a database with information about the customer and their gaming activity. The use of the existing database to further incorporate customer preferences is a logical extension of a casino's marketing strategy.

One popular type of casino gaming device is a gaming machine such as is known in the art as slots, video poker or other similar game. It is contemplated that an input or reader device is provided to facilitate the implementation of the casino customer service system. The input or reader device may comprise a card reader or radio frequency identification (RFID) reader associated with a gaming machine or as a stand alone element. In an alternative embodiment, a gaming machine may include a touch screen, configured with biometric identification ability, which serves as the input device.

Many casino customers enjoy playing table games such as blackjack, roulette, craps and poker. In order to provide customers who play these table games with the same type of service, it is contemplated that the casino employees who work in the pit area in proximity to the tables may have a workstation which can serve as the input device for the casino customer service system. Thus, the pit personnel can operate the casino customer service system in a similar manner to how they operate the casino customer rewards system with interaction at their workstation. A card or an RFID identification means can be used at a table game as well.

In one embodiment of the casino customer service system, the first or second communication link comprises a mobile device that is configured for wireless communication. It is contemplated that the mobile device may be handled by a waitress as she takes a beverage order which she can deliver electronically to the bar or lounge to be prepared, and subsequently receive confirmation that the beverage order has been prepared. Alternatively, the same information may be transmitted to the bar or lounge so that the beverages are waiting for the waitress when waitress arrives at the bar or lounge.

In one embodiment of the casino customer service system, the database is adapted to collect and store any amount of customer preference information. While not exhaustive, the types of customer preference information that may be collected and stored in the database include beverage choices, snack item choices, and tobacco product choices.

In addition, with respect to beverage choices, the database may be configured to collect and store customer preferences differentiated by time of day, day of the week (weekday versus weekend) and a variety of other differentiating parameters.

The present invention further contemplates a method of providing service to a casino customer. In one embodiment, the method comprises collecting and storing customer preference information in a database. The method further contemplates providing the customer with a casino element, such as, without limitation, a card identifying the customer.

When the casino element is used as a part of the method, it is read to identify the customer and to locate the customer within the casino when it is presented to an input or reader device within the casino.

The method further comprises the step of electronically transmitting the location of the customer to a service center that prepares a preferred good and/or a preferred service for the customer. Once the good or service is prepared, the method of the invention contemplates delivering the good or service to the customer.

In one embodiment of the method, a further step comprises electronically transmitting the customer preference information to the service center for preparation of a preferred good or a preferred service. The method provides a high level of service and improves efficiency to enhance the experience of the customer when visiting a casino without a corresponding increase in casino personnel requirements.

The types of input or reader devices that are configured to read the casino element or card utilized as part of the method invention are described above. The method thus provides a novel means of providing personalized service to a customer when patronizing a casino. In addition, the types of customer preference information collected and stored in the database that is used as part of the method are described above.

Other advantages of the present invention will become apparent to those skilled in this art from the following description where there is shown and described a preferred embodiment of this invention, simply by way of the figures. As will be realized, the invention is capable of other different embodiments and its several details are capable of modification in various aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of this specification illustrate several aspects of the present invention and together with the description serves to explain the principles of the invention. In the drawings:

FIG. 1 is a block diagram of an example embodiment of the casino customer service system.

FIG. 2 illustrates in perspective view a mobile device used in the casino customer service system.

FIG. 3 illustrates an operational flow diagram of an exemplary method of operation.

FIG. 4 illustrates an operational flow diagram of another embodiment of an exemplary method of operation.

Reference will now be made in detail to various embodiments of the invention, an example of which is illustrated in the accompanying drawing.

### DETAILED DESCRIPTION OF THE INVENTION

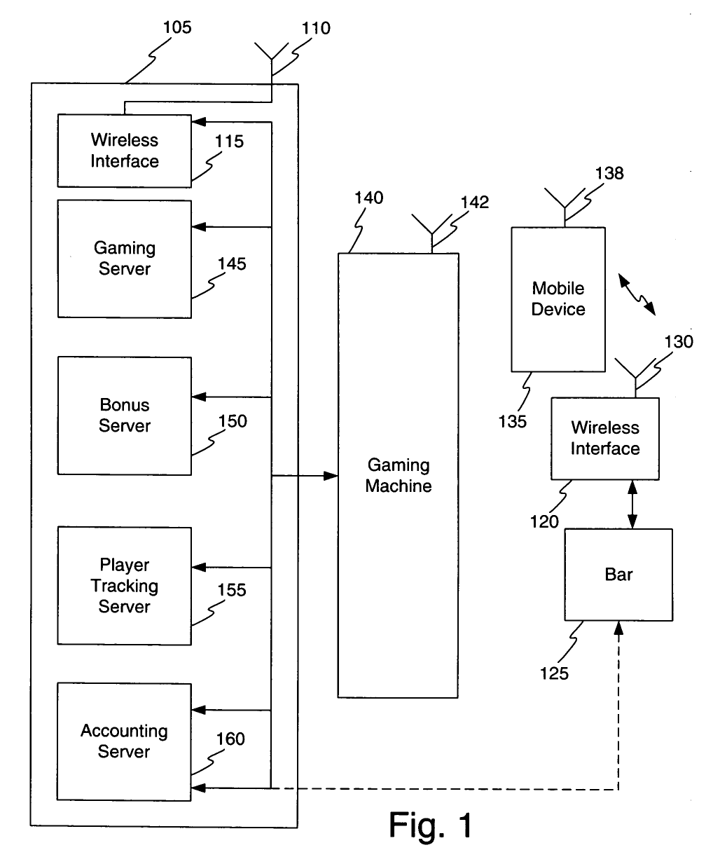

Reference is now made to the figures, and particularly, to FIG. 1 illustrating the operable components of a casino customer service system 100. It should be noted that this is but one example embodiment and other embodiments which do not depart from the scope of the invention may be enabled. In addition, the various features described herein may be enabled alone or in combination. For example, the casino customer service system 100 may be implemented in a wireless operating environment, or alternatively, the functional components may be connected through conventional wiring.

The casino customer service system 100 practiced in accordance with the present invention may be controlled by or in communication with a master server 105. In accordance with operation in a wireless environment, the master server 105 includes an antenna 110 which connects to a wireless interface 115. The antenna 110 and wireless interface 115 operate together to send and receive signals transmitted from a remote location. As is known in the art, a wireless interface 115 may also operate to demodulate, decode and otherwise process information to and from remote locations.

The master server 105 may comprise any type of computer system capable of storing data and providing data to one or more users over a network. Furthermore, as is known in the art, the master server 105 may also perform processing operations. As is more fully described below, the master server 105 includes one or more database systems that store data regarding, among other types, customer identification, customer gaming activity, and customer preference information.

The master server 105 communicates in this operational embodiment, with a plurality of wireless access points, illustrated in FIG. 1 as various devices, machines, and service points within a casino operation. As mentioned above, it is contemplated that the master server 105 may communicate with these various locations either through wired or wireless communication. When using wireless communication, any type of standard or protocol such as Mohitex, Ardis IEEE 802.11, UMTS, GPRS, IS-95, AMPS and/or Bluetooth may be used to implement the communication. Any type of wireless transmission may be implemented as well, including but not limited to optical, electromagnetic energy, radio or other frequency communication and infrared-type communications.

In this server based environment, a master server 105 may communicate with a wireless interface 120 located in a bar 125 as shown in order to facilitate to the service provided to customers in accordance with the present invention. The wireless interface 120 in the bar 125 includes an antenna 130 to facilitate communication. While FIG. 1 illustrates communication between the master server 105 and a bar 125, the master server may also communicate with a lounge area, which like a bar is adapted to prepare beverages, and other locations such as concession areas that may stock snack items and tobacco items.

It is also contemplated that the master server 105 may communicate with one or more mobile devices 135, with associated antennae 138, whose use is more fully described below. The mobile devices 135 may be carried by other casino personnel, such as waitresses to more fully promote the service that is contemplated by the system of the present invention.

The master server 105 may also communicate with gaming machines 140, having associated antennae 142, that customers play when visiting casinos. It is further contemplated for those customers that prefer to play table games that the master server 105 may communicate with workstations in the pit area where table games are located. Thus, it is contemplated that communication occurs between the master server 105 and all locations within the casino where customers are participating in gaming activity.

The master server 105 may incorporate a plurality of component servers that facilitate the operation of the casino service system 100. More particularly, a gaming server 145 is configured to promote the operation of the gaming machines, such as slot machines. The gaming server 145 may include database systems that store and transmit information relating to the individual games played on a gaming machine or, alternatively, simply be programmed to determined a winning play and/or an appropriate payout. Such an environment may be referred to as a central server system.

A bonus server 150 may be incorporated into the master server 105 and associated with the gaming server 145 to allow a customer to participate in jackpot games and/or qualify for promotions and/or free goods and services, referred to as comps, based on the level of the customer's gaming activity. The gaming server 145 and bonus server 150 may operate in unison to determine when a customer passes a threshold to qualify for a promotion or comp. Examples of these types of awards include, but are not limited to, progressives and mysteries.

An accounting server 160 may be provided to receive, store and transmit information relating to a customer's account. While not shown in FIG. 1, additional component servers may be incorporated into the master server 105 to perform other functions. For example, an administrative server may track expenditures by a customer during their visit to the casino. In addition, a concierge server (not shown) may be provided to assist in making reservations at restaurants and purchasing tickets for entertainment events. The accounting server 160 may store personal customer accounts which include payment information to allow a player/customer to purchase goods from the waitress and have the payment for the goods be deducted from their personal account.

In one embodiment of the casino customer service system 100, the master server 105 comprises a player tracking server 155 that may provide a number of important functions. More particularly, one important function of the player tracking server 155 is to assist in determining the location of a customer within the casino. The player tracking server 155 may be configured with a database that includes the location of all gaming machines and gaming tables within the casino. The player tracking server 155 may also be configured with other locating means such as GPS elements, to facilitate other location operations.

One example of how the player tracking server 155 generates player location data is through use of a player tracking system. Typically, a player utilizes a player tracking card or other readable element when wagering at a gaming machine or gaming table. A reading element at the gaming machine or gaming table reads the player data on the tracking card or element, and conveys the data to player tracking server 155. Given that the player tracking server 155 may correlate machine or table location to reader number, the player tracking server 155 may maintain a location database regarding the location within the casino of each player/customer.

The casino customer service system 100 of the present invention is designed to enhance the service provided to customers particularly through efficiency and personalization. In implementing the casino customer service system 100, the customer provides preference information to the casino, who collects and stores the information in a database. This collection effort can be accomplished in a variety of ways. More particularly, the customer can fill out an appropriate form that asks for the preference information and establishes an individual customer account. This may be done when the customer first visits the casino or at any time thereafter.

It is contemplated that the most commonly used preference information may be a beverage choice. As is known, casinos typically provide service to its customers through waitresses which walk around the casino floor and inquire of its customers whether they would like a beverage and if so, the type of beverage that they would like. Other preference information, such as preferred snack items and/or preferred tobacco products may also be given to the casino and entered into the database for that particular customer. This provides information to other hostess personnel in the casino with respect to the choices of the products that they are assigned to deliver. Other information may include the customer's name or nickname, residence, nationality, family information, history, profession, hobbies, interests, or other information that shows how valuable a player is to the casino in terms of amounts of play. In addition, it is contemplated that time and day information may optionally be associated with each preference, such as for example, a certain drink before noon, or a particular food item on the weekends. It is contemplated that any other information may be stored in the system about the player to facilitate an improved customer service experience for the property, the customer, or both.

It is also contemplated that customer preference information may be entered into the database in the player tracking server 155 by the bar personnel and/or waitresses that take orders from the customer while they are playing the casino games. This approach to collecting customer preference information may be used for the initial sign-up information, or, alternatively, may be used to change previously existing customer preference information.

It is further contemplated that the database containing the customer preference information may be associated with currently existing programs that are typically identified in the art as “player reward” programs, whereby casino customers are rewarded with promotion awards or comps based on the nature and extent of their gaming activity. The customer's gaming activity is typically monitored with a readable element, such as a plastic card generally referred to as a “player reward card”, that is encrypted with identifying information about the customer. Thus, if a customer has previously provided information to the casino in order to obtain a player reward card, the customer preference information may be combined with the personal information previously provided.

Thus, in one embodiment of the invention, such a readable element or card may be used for both the casino customer service system 100 and the casino's player reward program, and referred to purposes of describing this embodiment as a “player reward/tracking card”. The player reward/tracking card may not only be used to access a customer's previous gaming activity when it is presented while playing at the casino, but also to access the customer's preference information. In one embodiment, player rewards are personally delivered to the customer by the waitress while the customer is in the casino. In another embodiment, the orders of customers' beverages are prioritized for the waitress by providing beverages to customers whom the casino perceives as valuable customers based on the amount wagered by those particular customers.

Thus, in a typical scenario a player inserts the player reward/tracking card into a gaming machine, whereupon a signal is transmitted to the master server 105 and, in particular, to the gaming server 145 that is responsible for monitoring gaming activity, and the player tracking server 155 that preferably includes the database with customer preference information. The signal generated by the reading of the player reward/tracking card by the input or reader device (in this case, the card reader associated with the gaming machine) specifically identifies the location of the customer to a table or gaming machine associated with the reader. In one embodiment, the reader device comprises a radio frequency identification (RFID) reader configured to read a RFID tag embedded in the player reward/tracking card or other element possessed by the player. It is further contemplated that the RFID reader may be capable of reading the RFID signal when the customer sits down in a chair in front of a gaming machine 140. Thus the one or more readers could be located at any various location at or around the gaming machine. The player tracking server 155 may communicate with the bar 125 and provide information that the customer is at a particular gaming machine and prefers a certain beverage. The bar personnel may prepare the favorite beverage, and give it to a waitress with verbal or written instruction as to who the beverage is for and where in the casino it is to be delivered.

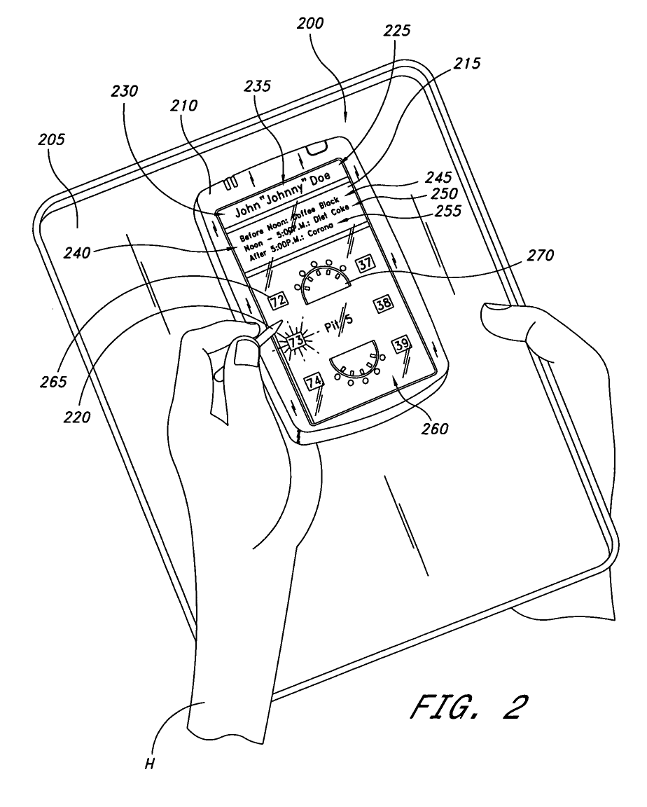

In a wireless operating environment, as stated above, it is contemplated that a waitress may carry the mobile device 135 with them as they make their rounds among the gaming machines and gaming tables. An exemplary mobile device is illustrated in FIG. 2. For purposes of FIG. 2, the mobile device is identified as 200. It is recognized that the device 200 in FIG. 2 is the same as the device 135 in FIG. 1. The waitress typically carries a tray 205, shown supporting the mobile device 200, on which she carries a notepad and beverage containers which are generally in the form of drink glasses.

It is contemplated that the mobile device 200 is configured to both transmit and receive information. The information may be sent to or from the master server 105 or to or from the bar 125. The mobile device 200 typically comprises a housing 210 and a display screen 215 for viewing various visual presentations.

As described, the mobile device 200 is shown positioned on the tray 205 that is being carried by a waitress. A stylus 220 is shown in one of the hands H of the waitress. It can be appreciated from the illustration of FIG. 2 that the mobile device 200 is easily and efficiently handled to promote its communication function. The embodiment of the mobile device 200 shown in FIG. 2 may take the form of a personal digital assistant or PDA. It is recognized that other configurations that facilitate portability may be used for the mobile device 200, for example, without limitation, a tablet computer.

The stylus 220 facilitates the ease of use of the touch capability associated with the display screen 215. Thus, the mobile device transmits information based on the touch location of the stylus 220 on a particular visual image in the display screen 215. In addition, the waitress may use the stylus 220 to access a wide variety of screen presentations that thus present an abundance of information.

The visual presentation of the display screen 215 in FIG. 2 is one of many possible presentations that may be accessed on the mobile device 200. On this exemplary screen, a top-screen portion 225 presents the name 230 (John Doe) to identify the customer to the waitress. In one embodiment, the visual presentation further presents the customer's nickname 235 (“Johnny”). This information allows the waitress, when interacting with the customer, to provide more personalized communication, which likely is going to create a more favorable impression with the customer.

A mid-screen portion 240 presents previously provided preference information regarding the customer's beverage choices. More particularly, in this exemplary embodiment, the beverage choices are differentiated based on time of day or based on day of the week. Thus, it is identified that this customer prefers black coffee in the morning hours before noon (245). The player prefers Diet Coke™ in the afternoon hours between noon and 5:00 P.M. (250) and, in the evening hours, the customer prefers the alcoholic beverage Corona beer (255). Thus, depending on the particular time of day, the casino has the preference information for this particular customer in its database and can thus specifically deliver the preferred beverage to the customer's location. The top-screen portion 225 or mid-screen portion 240 may indicate a player's nationality so that the player can be greeted in the player's native language. In addition, the top-screen portion 225 or mid-screen portion 240 may identify a player's gambling rating in relation to the player's reward levels. For example, a player could be identified as “Diamond” for the highest level or “Bronze” for the lowest level. Moreover, the system and hence the waitress is aware of the customer's presence at a machine or table when logging into the player tracking system, thereby reducing the amount of time before the customer is served.

In this embodiment the location is specifically identified in a bottom-screen portion 260 on the mobile device 200. The location information is presented in this embodiment in the form a map location on the casino floor. More specifically, specific gaming machines 265 are identified by their assigned casino number, in this case, 37, 38, 39, 72, 73 and 74. Two adjacent gaming tables 270, configured for the game of blackjack, are shown proximate to the gaming machine 265. For ease of location, the mobile device 200 identifies the location of the gaming tables 270 as being in pit 5 of the casino. Thus, with this mapped information, the waitress can be directed with accuracy to the location of the customer for delivery of the beverage choice. Advantageously, this all occurs automatically when the player presents his or her player reward/tracking card or element to a reader or dealer.

Particularly, through the previously described player tracking function, the customer is identified as playing at gaming machine 265 that is assigned numeral 73, as evidenced by the blinking light presented on the bottom-screen portion 260 of the display screen 215. It can thus be appreciated that the casino customer service system 100 of the present invention is adapted to identify this particular customer's preferences and the specific location for delivery of that beverage preference.

The player tracking function provides an additional advantage if the customer decides to change locations between the time that the preferred beverage is prepared and when it is delivered to the customer. More specifically, when the customer removes the reward/tracking card from the initial gaming machine 265 at which he or she was playing, the blinking light that previously identified his or her location is disabled. When the customer arrives at the next gaming machine 265, at which he or she now desires to play, upon insertion of the reward/tracking card into the card reader, a different mapped area may be provided in the bottom-screen display 260, showing the new location of the customer, now with a blinking light adjacent the new gaming machine location.

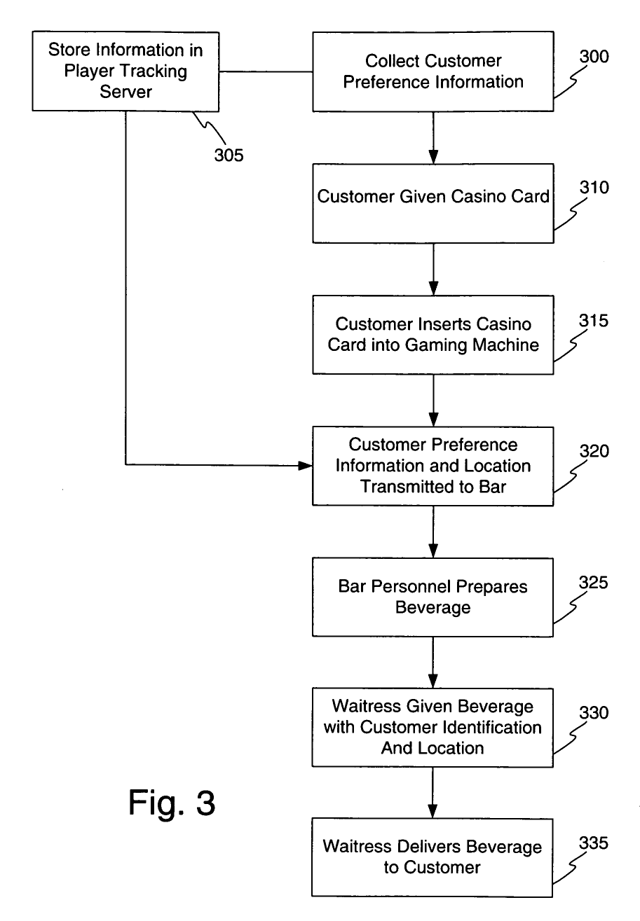

FIG. 3 presents an operational flow diagram of an exemplary method of operation. This diagram details an example method of the invention being implemented in an environment wherein a waitress does not have a mobile device and thus must rely on bar personnel or systems for order and delivery instructions. This is but one possible exemplary method and, as such, it is contemplated that other methods may be arrived at without departing from the scope of the invention.

At step 300, the casino collects customer preference information as part of a sign-up application. The customer preference information may be collected in any manner. The preference information is stored in the player tracking server of the casino customer service system at step 305. The customer preference information may be combined at this step with other personal information that may be used by the casino in operation of its customer reward program.

In order to participate in the casino's customer reward program and for operation of the customer service system, the customer is given a casino card, typically a card described as above as a player reward/tracking card, at step 310. In order to take advantage of the player reward program and to receive personalized service in accordance with the present invention, the customer presents the casino card during gaming activity. The operational flow diagram presented in FIG. 3 contemplates the customer playing at a gaming machine such as a slot machine. Thus, at step 315, the customer inserts the casino card into the gaming machine. This step initiates the transmission of information regarding the customer's preferences and location leading to subsequent service. This occurs at step 320.

The customer preference information and location is transmitted to a terminal or other electronic or printing element at the bar. Then, the bar personnel prepares the preferred beverage in anticipation of the beverage being delivered to the customer. This occurs at step at 325. Next, at step 330, when the waitress next comes to the bar, she is given the beverage with a printout or any other indicator of the customer's identification and location. This may be in the form of a tag associated with each beverage container. The waitress then, at step 335, delivers the beverage to the customer.

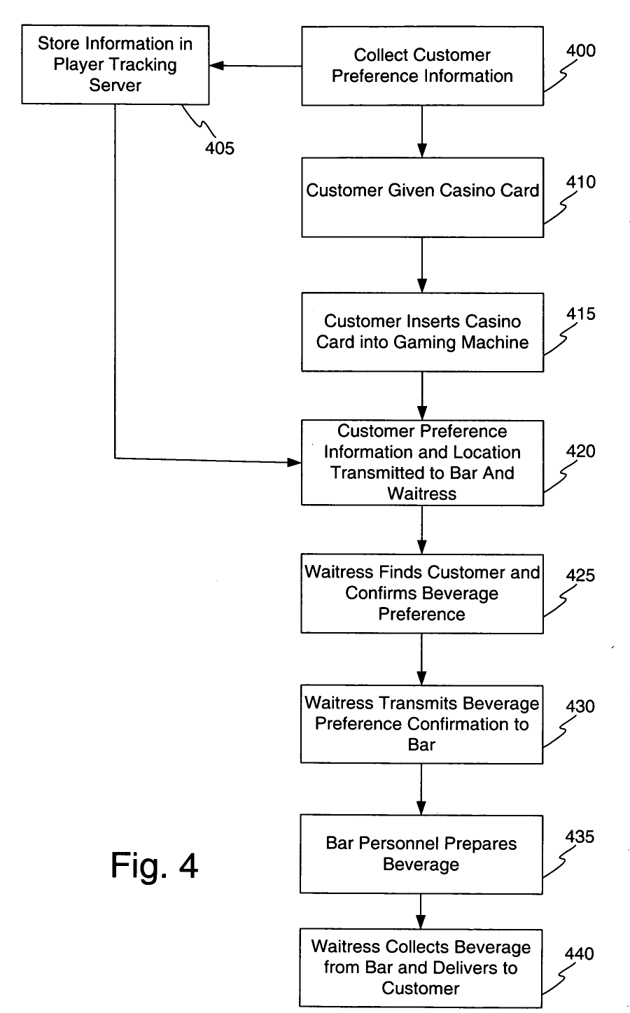

FIG. 4 presents an operational flow diagram showing an exemplary method of operation wherein the casino waitress is provided with a mobile device that is configured to receive and transmit information regarding the customer's preferences and location. Similarly to the diagram in FIG. 3, the casino initially collects customer preference information, typically as part of a sign-up application, at step 400. As described above, at step 405, the customer preference information is stored in a database in the player tracking server of the casino customer service system. Contemporaneously, the customer is given a casino card (player reward/tracking card) to use during his gaming activity at step 410.

When the customer begins his gaming session, he or she inserts the casino card into the gaming machine, as at step 415. At step 420, the customer preference information and the location of gaming activity is transmitted to the bar location and the waitress. It is contemplated that the waitress receives this information on the mobile device in her possession. While step 420 shows the simultaneous transmission of information to both the bar and waitress, it is within the scope of the invention for the information to be transmitted to either the bar or the waitress alone.

When the casino customer service system is implemented by transmission of the information to the waitress, she may find the customer at step 425 and confirm the customer's beverage preference. Upon receiving this confirmation from the customer, the waitress, at step 430, then transmits the beverage preference confirmation to the bar. Alternatively, the waitress would not have to first confirm the drink, but instead it could automatically be prepared in the waitress's absence and upon return to the bar the beverage would be picked up for delivery to the customer. In variations of this embodiment, the player tracking server has a timer which will automatically alert the waitress to provide a fresh beverage to the player at regular intervals of time. The mobile device also may have a place for the waitress to input the periodic frequency for beverage service of the player based on the player's request.

The bar personnel then proceeds to prepare the preferred beverage at step 435. The bar personnel may or may not transmit a message to the waitress indicating that the beverage has been prepared and is ready for pick-up. In the final step 440, the waitress arrives to collect the beverage from the bar and then delivers it to the customer.

In summary, the casino customer service system of the present invention provides greater personalized service than is presently known and thus promotes an enhanced gaming experience for casino customers. In addition, the casino customer service system promotes efficiency and operates to reduce personnel requirements.

In variations to the embodiments described above, it is contemplated that the customer may be awarded progressive or mystery awards by the waitress using the system described herein. In addition, other awards or comps may also be provided. In one embodiment the system operates in real time such that a player or customer may interact with the gaming machine to call a waitress to the machine or table. The gaming machine may also have an interactive menu display that allows a player to directly order a beverage or snack for preparation and subsequent delivery. Furthermore, as mobile gaming is implemented, mobile gaming devices provided to a customer for gaming activity may be configured with the capability to call for a waitress and/or have an interactive menu display for use as described above. It is also contemplated that the mobile gaming device may be utilized to provide player location to the waitress. Likewise, the pit boss could also call a waitress to the table. In addition, it is contemplated that the number or value of drinks or comps may be tracked and recorded by the system described herein. This data may be used to provide additional comps to players who have not received free refreshments or for marketing purposes to direct advertisements or other services products to certain players.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment disclosed herein was chosen and described to provide the best illustrations of the principles of the invention and its practical application to thereby to enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally and equitably entitled.

What is claimed is:

1. A system for providing service to a casino customer, comprising:
a database for collecting and storing customer preference information;
a service center for preparing preferred goods and services for the customer;
a tracking server, responsive to an input or reader device, for tracking the location of the customer;
a first communication link between the database and the service center to send customer preference information to the service center;
a second communication link between the tracking server and the service center to send customer location information to the service center; and
means for delivering the preferred goods and services to the customer.

2. The casino customer service system of claim 1, wherein the service system is associated with a casino customer reward system that rewards the customer based on gaming activity.

3. The casino customer service system of claim 1, wherein the input or reader device comprises a card reader associated with a gaming machine.

4. The casino customer service system of claim 1, wherein the input or reader device comprises a touch screen, configured with biometric identification ability, associated with a gaming machine.

5. The casino customer service system of claim 1, wherein the input or reader device comprises a workstation.

6. The casino customer service system of claim 1, wherein the first or second communication link comprises a mobile device configured for wireless communication.

7. The casino customer service system of claim 1, wherein the customer preference information comprises a beverage choice.

8. The casino customer service system of claim 1, wherein the customer preference information comprises a snack item choice.

9. The casino customer service system of claim 1, wherein the customer preference information comprises a tobacco product choice.

10. The casino customer service system of claim 1, wherein the customer preference information is differentiated by time of day.

11. The casino customer service system of claim 1, wherein the customer preference information is differentiated by day of the week.

12. The casino customer service system of claim 1, wherein beverages are delivered to customers repeatedly after a period of time elapses.

13. The casino customer service system of claim 1, wherein the player's nationality is identified as an item of customer preference information.

14. A method of providing service to a casino customer during game play, comprising the steps of:
collecting and storing customer preference information in a database;
providing the customer with an identification element that identifies the customer;
reading the identification element to locate the customer in the casino when the identification element is presented to a reader device in the casino;
electronically transmitting the customer preference information to a customer service center to have a preferred good or a preferred service prepared for the customer; and
delivering the preferred good or the preferred service to the customer, wherein the customer is located within the casino based on the reading of the identification element.

15. The method of providing service to a casino customer as in claim 14, further comprising the step of electronically transmitting the location of the customer to the customer service center.

16. The method of providing service to a casino customer as in claim 14, further comprising the step of associating the service with a casino customer reward system that rewards the customer based on gaming activity.

17. The method of providing service to a casino customer as in claim 14, wherein the reader device comprises a card reader associated with a gaming machine.

18. The method of providing service to a casino customer as in claim 14, wherein the identification element is configured with radio frequency identification which transmits a signal to a radio frequency identification reader.

19. The method of providing service to a casino customer as in claim 14, wherein the reader device comprises a biometric identification device associated with a gaming machine.

20. The method of providing service to a casino customer as in claim 14, wherein the input device comprises a workstation used to enter customer preference information.

21. The method of providing service to a casino customer as in claim 14, wherein the customer preference information comprises a beverage choice.

22. The method of providing service to a casino customer as in claim 14, wherein the customer preference information comprises a snack item choice.

23. The method of providing service to a casino customer as in claim 14, wherein the customer preference information comprises a tobacco product choice.

24. The method of providing service to a casino customer as in claim 14, wherein the customer preference information is differentiated by time of day.

25. The method of providing service to a casino customer as in claim 14, wherein the customer preference information is differentiated by day of the week.

26. The method of providing service to a casino customer as in claim 14, wherein beverages are delivered to customers repeatedly after a period of time elapses.

27. The method of providing service to a casino customer as in claim 14, wherein the player's nationality is identified as an item of customer preference information.
